(19) United States
(12) Patent Application Publication
(10) Pub. No.: US 2024/0068496 A1
(43) Pub. Date: Feb. 29, 2024

(54) QUCIK RELEASE CLAMP DEVICE

(71) Applicant: KSI Group, LLC, Savage, MN (US)

(72) Inventor: Todd Ellinger, Plymouth, MN (US)

(21) Appl. No.: 18/455,024

(22) Filed: Aug. 24, 2023

Related U.S. Application Data
(60) Provisional application No. 63/400,922, filed on Aug. 25, 2022.

(51) Int. Cl. F16B 2/08; F16H 1/16

(52) U.S. Cl. CPC F16B 2/08; F16H 1/16

(57) ABSTRACT

A clamp device includes a clamp housing, a band member, a plurality of first mating features defined at the band member, a screw member, a plurality of second mating features defined at the screw member, the plurality of second mating features being complementary to the plurality of first mating features such that the plurality of second mating features are configured to engage with the plurality of first mating features, a screw plate movably coupled to the clamp housing, the screw member coupled to the screw plate such that the screw member is movable with the screw plate relative to the band member, and at least one screw stability mechanism at the clamp device and configured to reduce at least one degree of freedom of movement of the screw member relative to the band member.

### RELATED APPLICATION

This disclosure claims priority to U.S. provisional patent application No. 63/400,922, filed on Aug. 25, 2022.

### TECHNICAL FIELD

This disclosure relates generally to embodiments of a clamp device, such as a quick release clamp device, such as a quick release worm gear clamp. Such clamp device embodiments disclosed herein can include one or more screw stability mechanisms configured to reduce at least one degree of freedom of movement of a screw member of the clamp device and, thereby, can act to increase the reliability and installation efficiency associated with the clamp device.

### BACKGROUND

A quick release clamp can be used to secure one element to another. To secure one element to another, typically the quick release clamp includes a band that is placed around the securement interface between the two elements being secured together. To remove excess slack and increase the tightness of the securement force provided by the quick release clamp, a screw member of the quick release clamp can be moved completely off of complementary mating serrations at the band to allow the band to be fed through the clamp housing and tightened. Then, when excess slack in the band circumference has been so removed, the screw member threads can be moved back onto the complementary mating serrations at the band, preventing the band material from moving in either direction through the housing and, when so positioned, the screw member can be rotationally actuated to cause the band to be incrementally tightened around the securement interface between the two elements being secured together.

### SUMMARY

Currently available quick release clamps can provide some conveniences (e.g., easier installation at a range of angles and circumstances) as a result of the screw member's ability to move relative to, and off of, the band member and the band member's complementary mating serrations. However, this same feature relating to the screw member's ability to move relative to, and off of, the band member and the band member's complementary mating serrations can also create unreliability and installation inefficiencies. For example, because the screw member can easily and often unintentionally move relative to the band member and the band member's complementary mating serrations, oftentimes during installation of currently available quick release clamps the screw member will inadvertently “flop,” or inadvertently move, relative to the band member and the band member's complementary mating serrations. This inadvertent “flop” of the screw member during installation can cause the screw member to undesirably catch at the band member's complementary mating serrations and impede the ability of the installer to draw the band material through the housing to initially tighten and/or preposition the clamp on the mating assembly. Conversely, this same effect can impede the clamp remover's ability to draw the band material through the housing in the opposite direction when attempting to loosen or remove the clamp entirely from the mating assembly.

Accordingly, embodiments disclosed herein include a clamp device that includes one or more screw stability mechanisms at the clamp device. The one or more screw stability mechanisms included at the clamp device can be configured to reduce at least one degree of freedom of movement of the clamp device's screw member and, thereby, can act to increase the reliability and installation efficiency associated with the clamp device. For instance, such one or more screw stability mechanisms included at the clamp device can still permit some degree of movement of the screw member relative to the band member, and relative to the band member's complementary mating serrations, sufficient to allow the screw member to lift off of the band member's complementary mating serrations and thus allow for tightening of the band without needing to actuate the screw member yet at the same time such one or more screw stability mechanisms included at the clamp device can reduce at least one degree of freedom of movement of the clamp device's screw member in a way that reduces instances of screw member “flop” during installation. For example, embodiments of the one or more screw stability mechanisms included at the clamp device can reduce the screw member's degree of freedom of movement at least in a direction toward the band member (e.g., in a direction perpendicular to the band member as the screw member is moved toward the band member to engage the band member's complementary mating serrations) by creating an interference structure between the screw plate and the clamp housing that acts to increase the amount of force needed, as compared to traditional quick release worm gear clamp devices, to move the screw member toward the band member to engage the complementary serrations and the band and screw members. This interference structure that the one or more screw stability mechanisms, such as between the screw plate and the clamp housing, can be configured to provide tactile feedback to a user as the user applies force to move the screw member toward the band member, such as a feel similar to a light switch as a user applies force to move the light switch from an on/off position to the other of the on/off position. As such, clamp device embodiments disclosed herein can increase the reliability and installation efficiency associated with the clamp device by reducing instances of unintended screw member “flop” during clamp installation.

One embodiment includes a clamp device (e.g., quick release worm gear clamp). This clamp device embodiment includes a clamp housing, a band member, a plurality of first mating features defined at the band member, a screw member, a plurality of second mating features defined at the screw member, the plurality of second mating features being complementary to the plurality of first mating features such that the plurality of second mating features are configured to engage with the plurality of first mating features, a screw plate (or “bridge”) movably coupled to the clamp housing, the screw member coupled to the screw plate such that the screw member is movable (e.g., movable with the screw plate, such as rotationally movable within the screw plate) relative to the band member, and at least one screw stability mechanism at the clamp device and configured to reduce at least one degree of freedom of movement of the screw member relative to the band member.

In a further embodiment of this clamp device, the at least one screw stability mechanism is included on at least one of a wall (e.g., sidewall, such as an upper sidewall surface) of the clamp housing and a wall of the screw plate (or “bridge”). As one such example, the at least one screw stability mechanism can be included on at least one wall (e.g., sidewall, such as an upper sidewall surface) of the clamp housing interfacing with the screw plate such that the at least one screw stability mechanism is positioned so as to contact the screw plate at some, or all, positions of the screw plate as the screw plate moves (e.g., pivots) relative to the fixed clamp housing. As another such additional or alternative example, the at least one screw stability mechanism can be included at at least one wall of the screw plate interfacing with the clamp housing (e.g., interfacing with a screw plate housing portion of the clamp housing) such that the at least one screw stability mechanism is positioned so as to contact the clamp housing at some, or all, positions of the screw plate as the screw plate moves (e.g., pivots) relative to the clamp housing.

In a further embodiment of this clamp device, the at least one screw stability mechanism can be selected from the group consisting of: a change (e.g., increase or decrease) in wall thickness at a wall of the clamp housing (e.g., at a screw plate housing portion of the clamp housing) and/or the screw plate positioned to contact the screw plate or clamp housing, respectively, at some, but not all, positions of the screw plate as the screw plate moves relative to the clamp housing, a change (e.g., increase or decrease) in an angle of a wall of the clamp housing (e.g., at a screw plate housing portion of the clamp housing) positioned to contact the screw plate at some, but not all, positions of the screw plate as the screw plate moves relative to the clamp housing, a change in a thickness of the screw plate at a location on the screw plate that is positioned to contact the clamp housing (e.g., a screw plate housing portion of the clamp housing) at some, but not all, positions of the screw plate as the screw plate moves relative to the clamp housing, a change (e.g., increase or decrease) in an angle of a wall at the screw plate at a location on the screw plate that is positioned to contact the clamp housing (e.g., a screw plate housing portion of the clamp housing) at some, but not all, positions of the screw plate as the screw plate moves relative to the clamp housing, an interference member that extends out from the clamp housing (e.g., at a screw plate housing portion of the clamp housing) at a location that is positioned to contact the screw plate at at least some (e.g., all) positions of the screw plate as the screw plate moves relative to the clamp housing, and an interference member that extends out from the screw plate at a location that is positioned to contact the clamp housing (e.g., at a screw plate housing portion of the clamp housing) at at least some (e.g., all) positions of the screw plate as the screw plate moves relative to the clamp housing.

Another embodiment includes a quick release worm gear clamp. This clamp includes a clamp housing, a band member movable relative to the clamp housing, a screw member movable relative to the clamp housing and the band member, a screw plate movably coupled to the clamp housing, and a screw stability mechanism at the clamp housing and/or at the screw plate. The band member includes a plurality of first mating features. The screw member includes a plurality of second mating features, with the plurality of second mating features being complementary to the plurality of first mating features such that the plurality of second mating features are configured to engage with the plurality of first mating features when the screw member is moved in a first direction to bring the screw member into contact with the band member. The screw member is coupled to the screw plate such that as the screw member is moved in the first direction, the screw plate is moved relative to the clamp housing. The screw stability mechanism is configured to provide an interference force that increases a resistance to movement of the screw member in the first direction.

In a further embodiment of this clamp, the screw stability mechanism includes a first interference member at the clamp housing and a second interference member at the screw plate. The first interference member can be configured to contact the second interference member to provide the interference force that increases the resistance to movement of the screw member in the first direction toward the band member.

In a further embodiment of this clamp, the first interference member at the clamp housing includes a first dimple that protrudes out from a first sidewall (e.g., an upper sidewall, a side sidewall, etc.) of the clamp housing into an interior of the clamp housing. The first interference member at the clamp housing can further include a second dimple that protrudes out from a second sidewall of the clamp housing into the interior of the clamp housing, where the second sidewall is different than the first sidewall. For example, the first sidewall can be adjacent to the second sidewall. In one particular embodiment, the second interference member at the screw plate can include a flange positioned between the first dimple and the second dimple. The flange can contact the first dimple and the second dimple to provide the interference force that increases the resistance to movement of the screw member in the first direction toward the band member. The flange can include a first flange perimeter surface and a second flange perimeter surface that is different than the first flange perimeter surface, where the first flange perimeter surface is configured to contact the first dimple within the clamp housing, and where the second flange perimeter surface is configured to contact the second dimple within the clamp housing. For instance, the first flange perimeter surface can be opposite the second flange perimeter surface. In one such example, the screw plate can define a first cutout adjacent the first dimple and extending inward at the screw plate adjacent the first sidewall, and the screw plate can define a second cutout adjacent the second dimple and extending inward at the screw plate adjacent the second sidewall. The screw plate can receive the first dimple at the first cutout adjacent the first sidewall, and the screw plate can receive the second dimple at the second cutout adjacent the second sidewall. The flange can extend out from the screw plate within the clamp housing at a location between the first cutout and the second cutout. In an additional or alternative example, the screw plate can further include a first axle rotationally coupled to the clamp housing and a second axle rotationally coupled to the clamp housing with the flange being located between the first axle and the second axle. For instance, the flange can be located between the first axle and the second axle at a different elevation on the screw plate than an elevation of the first axle and the second axle on the screw plate. When the plurality of second mating features are further engaged with the plurality of first mating features via actuation (e.g., rotation) of the screw, the clamp can be configured such that actuation of the screw member causes the band member to move relative to the clamp housing so as to tighten or loosen the band member. For instance, the clamp can be configured such that actuation (e.g., rotation) of the screw member in a first direction (e.g., a first rotational direction) causes the band member to move relative to the clamp housing in a first direction so as to tighten the band member, and the clamp can be configured such that actuation of the screw member in a second, opposite direction causes the band member to move relative to the clamp housing in a second, opposite direction so as to loosen the band member.

In a further embodiment of this clamp, the screw stability mechanism includes a sidewall of the clamp housing, and this sidewall of the clamp housing includes a skewed (e.g., non-perpendicular, non-parallel, etc.) sidewall orientation relative to the screw plate.

In a further embodiment of this clamp, the screw stability mechanism includes a non-uniform thickness at a sidewall of the clamp housing, and the non-uniform thickness at the sidewall of the clamp housing includes an increase in sidewall thickness at a location at the clamp housing configured to contact the screw plate.

In a further embodiment of this clamp, the screw stability mechanism includes a non-uniform thickness at an axle of the screw plate, and this non-uniform thickness at the axle of the screw plate is configured to contact the clamp housing. Additionally or alternatively, the clamp in some embodiments can include the screw stability mechanism as a non-uniform thickness at a fixed dome component that houses the screw plate axle such that this non-uniform thickness at the fixed dome component is configured to contact the screw plate axle housed at the fixed dome component and thereby provide at least some degree of resistance to rotation of the screw plate (e.g., resistance against unintentional screw plate rotation).

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a perspective view of an embodiment of a clamp device that includes at least one screw stability mechanism in an exemplary form of a change in thickness at a wall of the clamp housing (e.g., at a screw plate housing portion of the clamp housing) and positioned to contact the screw plate at at least some positions of the screw plate as the screw plate moves relative to the clamp housing.

FIG. 2 is a perspective view of an embodiment of a clamp device that includes at least one screw stability mechanism in an exemplary form of a change in an angle of a wall of the clamp housing (e.g., at a screw plate housing portion of the clamp housing) and positioned to contact the screw plate at at least some positions of the screw plate as the screw plate moves relative to the clamp housing.

FIG. 3 illustrates two side elevational views, of different sides, of an embodiment of a screw plate for use with a clamp device, where the screw plate includes at least one screw stability mechanism in an exemplary form of, respectively, (i) a change (e.g., increase or decrease) in an angle of a wall at the screw plate at a location on the screw plate that is positioned to contact the clamp housing (e.g., a screw plate housing portion of the clamp housing) at at least some positions of the screw plate as the screw plate moves relative to the clamp housing and (ii) a change in a thickness of the screw plate at a location on the screw plate that is positioned to contact the clamp housing (e.g., a screw plate housing portion of the clamp housing) at at least some positions of the screw plate as the screw plate moves relative to the clamp housing.

FIG. 4 is a perspective view of an embodiment of a clamp device that includes at least one screw stability mechanism in an exemplary form of an interference member that extends out from the clamp housing at a location that is positioned to contact the screw plate at at least some positions of the screw plate as the screw plate moves relative to the clamp housing.

FIG. 5 is a perspective view of an embodiment of a clamp device that includes at least one screw stability mechanism in an exemplary form of an interference member that extends out from the screw plate at a location, different from that illustrated for the embodiment at FIG. 4, that is positioned to contact the clamp housing (e.g., at a screw plate housing portion of the clamp housing) at at least some positions of the screw plate as the screw plate moves relative to the clamp housing.

FIG. 6 is a side elevational view of an embodiment of a screw plate for use with a clamp device, where the screw plate includes at least one screw stability mechanism in an exemplary form of an interference member that extends out from the screw plate at a location that is positioned to contact the clamp housing (e.g., at a screw plate housing portion of the clamp housing) at at least some positions of the screw plate as the screw plate moves relative to the clamp housing.

FIGS. 7A and 7B show another embodiment of a clamp device that includes at least one screw stability mechanism in an exemplary form of an interference member that extends out from the screw plate and includes at least one screw stability mechanism in an exemplary form of an interference member that extends out from the clamp housing adjacent to the screw plate's at least one interference member so as to create therebetween an interference contact that is configured to provide tactile feedback to a user when the user applies a force to move the screw member toward the band member to engage to screw member's serrations at the band member's serrations. In particular, FIG. 7A is an elevational view of this clamp device embodiment and FIG. 7B is a close up elevational view of the clamp housing and screw plate showing the screw stability mechanism, in the form of an interference member, at each of the clamp housing and the screw plate.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Clamp device embodiments disclosed herein can increase the reliability and installation efficiency associated with the clamp device. Such clamp devices can include, for instance, quick release worm gear type clamps, though other types of clamp devices are within the scope of the present disclosure. To help increase reliability and installation efficiency, clamp device embodiments disclosed herein can include one or more screw stability mechanisms at the clamp device. The one or more screw stability mechanisms included at the clamp device can be configured to reduce at least one degree of freedom of movement (e.g., in a direction generally normal to the band member portion received at the clamp housing) of the clamp device's screw member and, thereby, can act to increase the reliability and installation efficiency associated with the clamp device. For instance, such one or more screw stability mechanisms included at the clamp device can still permit some degree of movement (e.g., in a direction generally normal to the band member portion received at the clamp housing) of the screw member relative to the band member and the band member's complementary mating serrations sufficient to allow the screw member to lift off of the band member's complementary mating serrations and thus allow for tightening of the band without needing to actuate the screw member yet at the same time such one or more screw stability mechanisms included at the clamp device can reduce at least one degree of freedom of movement of the clamp device's screw member in a way that reduces instances of screw member “flop” during installation.

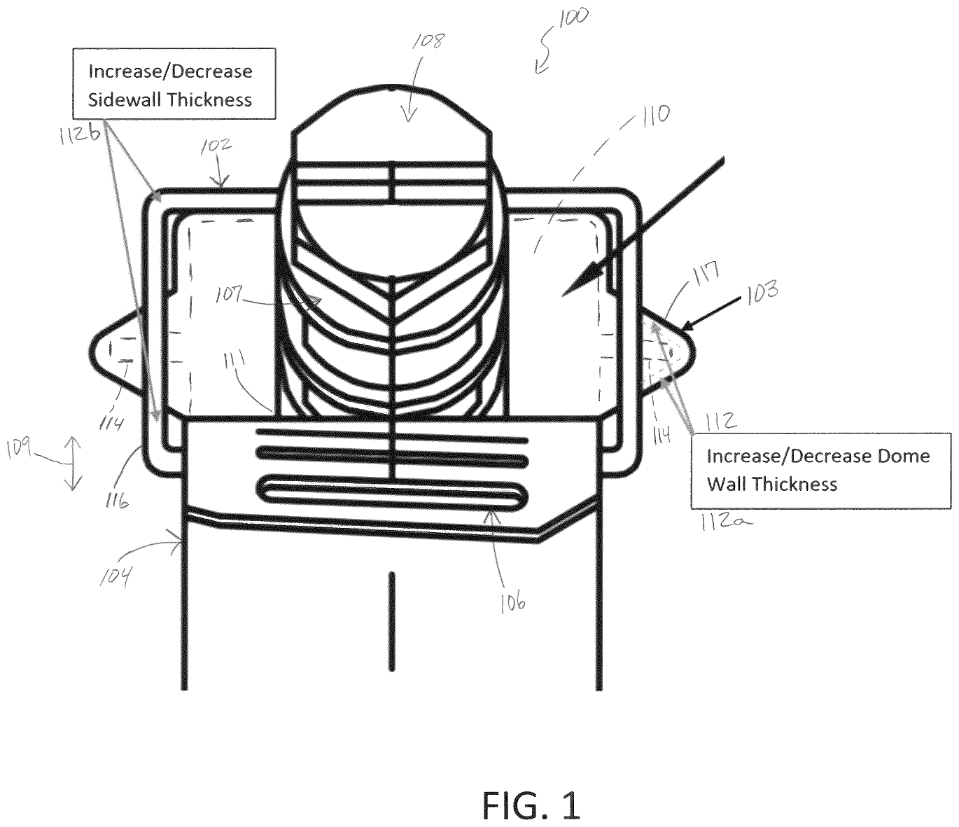

FIG. 1 is a perspective view of an embodiment of a clamp device 100. The clamp device 100 includes a clamp housing 102, a band member 104, a screw member 108, a screw plate 110 (e.g., trunnion, bridge, etc.), and at least one screw stability mechanism 112 at the clamp device 100. A plurality of first mating features 106 are included and defined at the band member 104. A plurality of second mating features 107 are included and defined at the screw member 108. The plurality of second mating features 107 can be complementary to the plurality of first mating features 106 such that the plurality of second mating features 107 are configured to engage with the plurality of first mating features 106. When the plurality of second mating features 107 are engaged with the plurality of first mating features 106, the screw member 108 can be actuated (e.g., torque applied to rotate the screw member 108) to cause the band member 104 to move relative to the clamp housing 102 so as to tighten or loosen the band member 104 at an installation location. For example, actuating the screw member 108 in a first direction (e.g., applying torque in a first rotational direction at the screw member 108) can cause the band member 104 to move relative to the clamp housing 102 in a first direction so as to tighten the band member 102, and actuating the screw member 108 in a second, different direction (e.g., applying torque in a second, different (e.g., opposite) rotational direction at the screw member 108) can cause the band member 104 to move relative to the clamp housing 102 in a second, different (e.g., opposite) direction so as to loosen the band member 102.

To help facilitate installation of the clamp device at various angles, the screw member 108 can be configured to move relative to the clamp housing 102. For example, in some embodiments, the screw member 108 can be configured to move in a direction 109 generally normal to the band member 104, for instance generally normal to a portion of the band member 104 received at the clamp housing 102. To facilitate such movement of the screw member 108 relative to the clamp housing 102, the screw member 108 can be coupled to the screw plate 110, such as at coupling 111, and the screw plate 110 can be movably coupled to the clamp housing 102. For instance, in the illustrated embodiment, the screw plate 110 can be rotationally coupled to the clamp housing 102 such that the screw plate 110 is configured to rotate, or pivot, relative to the clamp housing 102. In some embodiments, such as that illustrate here, the screw plate 110 can include one or more axles 114 that are rotationally coupled to the clamp housing, for instance rotationally coupled to the clamp housing 102 at a screw plate housing portion 103 of the clamp housing 102, and the screw plate 110 can be configured to rotate, about an axis of the axles 114, relative to the clamp housing 102 (e.g., and relative to the screw plate housing portion 103 of the clamp housing 102). Moreover, because the screw member 108 is coupled to the movable screw plate 110, the screw member 108 can also be movable, with the screw plate 110, relative to the band member 104 in the direction 109.

To help increase the reliability and installation efficiency associated with the clamp device 100, the clamp device 100 can include the at least one screw stability mechanism 112 at the clamp device 100. The at least one screw stability mechanism 112 can be configured to reduce at least one degree of freedom of movement of the screw member 108 relative to the band member 104. In particular, the at least one screw stability mechanism 112 can be configured to reduce at least one degree of freedom of movement of the screw member 108, relative to the band member 104, in the direction 109. For instance, the screw stability mechanism 112 can be configured to contact the screw plate 110 at some, but not all, rotational positions of the screw plate 110 so as to restrict rotational movement of the screw plate 110 relative to the clamp housing 102 and band 104, and this restricted rotational movement of the screw plate 110, facilitated by the presence of the screw stability mechanism 112, can act to restrict movement of the screw member 108 in the direction 109. Accordingly, the screw member 108 of the clamp device 100 can be configured to have restricted movement in the direction 109 relative to a same or similar clamp device lacking screw stability mechanism 112. In addition, the presence of the screw stability mechanism can act to provide tactile feedback to a user when the user is apply force to move the screw member 108 relative to the band 104.

The clamp device 100 illustrated at FIG. 1 includes the at least one screw stability mechanism 112 in an exemplary form of a change in thickness at a wall of the clamp housing 102. For example, this can include the at least one screw stability mechanism 112b in the exemplary form of a change in thickness at a wall 116 of the clamp housing 102 and/or the at least one screw stability mechanism 112a in the exemplary form of a change in thickness at a wall 117 of the screw plate housing portion 103 of the clamp housing 102. The at least one screw stability mechanism 112a can be positioned to contact the screw plate 110 (e.g., an axle 114 of the screw plate 110) at some or all positions of the screw plate 110 as the screw plate 110 moves relative to the clamp housing 102 and accordingly the at least one screw stability mechanism 112a can be configured to apply a rotational impediment force on the screw plate 110 (e.g., at the axle 114) to restrict rotational movement of the screw plate 110 and, thereby, restrict movement of the screw member 108 in the direction 109. And, the at least one screw stability mechanism 112b can be positioned to contact the screw plate 110 at some, but not all, positions of the screw plate 110 as the screw plate 110 moves relative to the clamp housing 102 and accordingly the at least one screw stability mechanism 112b can be configured to apply a rotational impediment force on the screw plate 110, at some but not all rotational positions of the screw plate 110, to restrict rotational movement of the screw plate 110 and, thereby, restrict movement of the screw member 108 in the direction 109.

The at least one screw stability mechanism 112 in the form of a change in thickness at a wall of the clamp housing 102, including at the screw plate housing portion 103, can be present in a variety of configurations. For instance, a material thickness of one or more walls 116 (e.g., at two opposite sidewalls) at the clamp housing 102 and/or one or more walls 117 (e.g., at two opposite sidewalls) at the screw plate housing portion 103 can be changed (e.g., increased or decreased) to provide progressively increasing friction/resistance between the wall(s) 116, 117 and the screw plate 110 to which the screw member 108 is coupled. Namely, in one example, the material thickness of one or more walls 116 at the clamp housing 102 and/or one or more walls 117 at the screw plate housing portion 103 can increase in a direction along such wall(s) 116, 117 moving toward the band member 104. In another example, the material thickness of the screw plate housing portion 103 can be increased in a direction toward the axle 114. Where the screw stability mechanism 112 includes a non-uniform thickness at a sidewall of the clamp housing 102, the non-uniform thickness at the sidewall of the clamp housing 102 can include an increase in sidewall thickness at a location at the clamp housing 102 configured to contact the screw plate 110. Additionally or alternatively, where the screw stability mechanism 112 includes a non-uniform thickness at one or both axle 114 of the screw plate 110, this non-uniform thickness at one or both axles 114 can be configured to contact the clamp housing 102 to provide the increased resistance to movement of the screw plate 110.

As one specific such example of the at least one screw stability mechanism 112 in the form of a change in thickness at a wall of the clamp housing 102, the at least one screw stability mechanism 112 can include a change in thickness at the wall 116 of the clamp housing 102 at one or more regions of the wall 116 (e.g., sidewall 116) adjacent (e.g., interfacing with) the screw plate housing portion 103 (e.g., adjacent, such as interfacing with, the axle 114). For instance, the wall 116 (e.g., sidewall 116) of the clamp housing 102 can increase in material thickness at one or more locations of the wall 116 (e.g., sidewall 116) adjacent (e.g., interfacing with) the screw plate housing portion 103 (e.g., adjacent, such as interfacing with, the axle 114). As one such further example, the wall 116 (e.g., sidewall 116) of the clamp housing 102 can increase in material thickness at one location of the wall 116 (e.g., sidewall 116) adjacent (e.g., interfacing with) a first screw plate housing portion 103 (e.g., adjacent, such as interfacing with, the left-hand axle 114 in FIG. 1) and at another, different location of the wall 116 (e.g., sidewall 116) adjacent (e.g., interfacing with) a second, different screw plate housing portion 103 (e.g., adjacent, such as interfacing with, the right-hand axle 114 in FIG. 1).

In addition to or alternative to one or more changes in thickness at the wall 116 of the clamp housing 102 at one or more regions of the wall 116 adjacent the screw plate housing portion 103, as another specific such example of the at least one screw stability mechanism 112 in the form of a change in thickness at a wall of the clamp housing 102, the at least one screw stability mechanism 112 can include a change in thickness at the wall 117 of the screw plate housing portion 103. For instance, the wall 117 (e.g., sidewall 117) of the screw plate housing portion 103 can increase in material thickness at one or more locations of the wall 117 (e.g., sidewall 117) adjacent (e.g., interfacing with) the clamp housing 102. For example, the wall 117 (e.g., sidewall 117) of the screw plate housing portion 103 can increase in material thickness at one or more locations of the wall 117 (e.g., sidewall 117) in a direction moving toward the clamp housing 102 such that a thickest portion of the wall 117 is a portion of the wall 117 closest to the clamp housing 102.

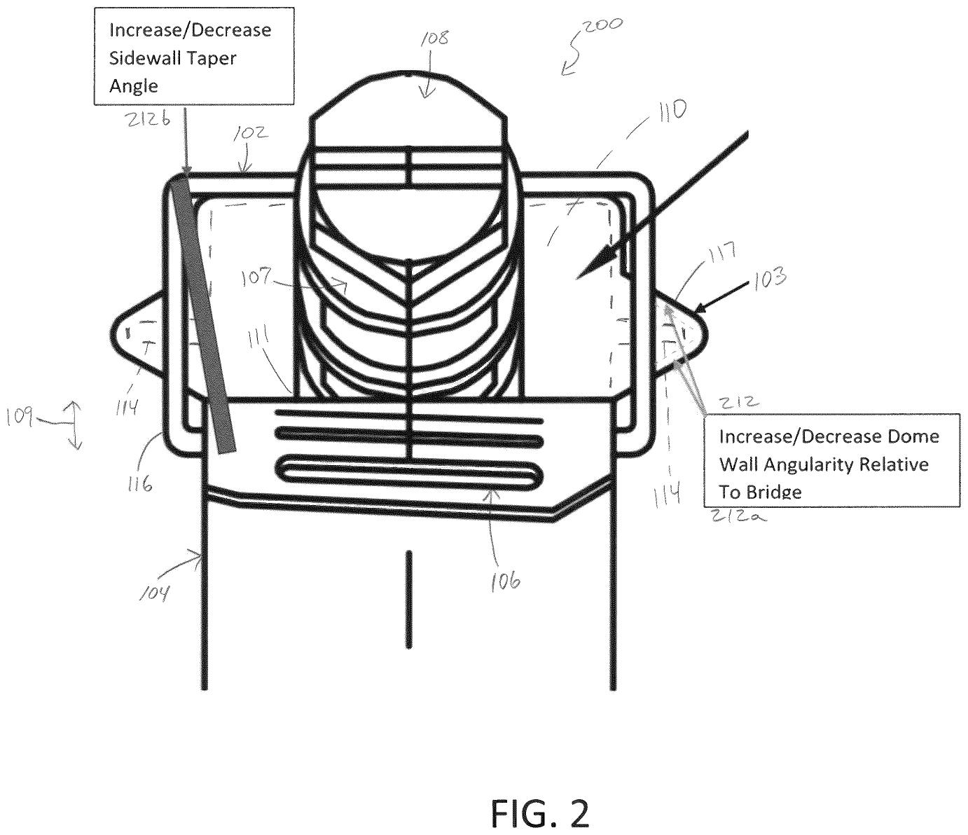

FIG. 2 is a perspective view of an embodiment of a clamp device 200. The clamp device 200 can be similar to, or the same as, the clamp device 100 described with respect to FIG. 1 except as noted here.

The clamp device 200 can include at least one screw stability mechanism 212 in an exemplary form of a change in an angle of a wall of the clamp housing 102. The wall (e.g., sidewall) of the clamp housing 102 forming the screw stability mechanism 212 can have a skewed orientation relative to the screw plate 110 while an adjacent wall (e.g., top sidewall) of the clamp housing 102 can be generally parallel to the screw plate 110. For example, this can include the at least one screw stability mechanism 212b in the exemplary form of a change in an angle of the wall 116 of the clamp housing 102 and/or the at least one screw stability mechanism 212a in the exemplary form of a change in an angle of the wall 117 of the screw plate housing portion 103 of the clamp housing 102. The at least one screw stability mechanism 212a can be positioned to contact the screw plate 110 (e.g., an axle 114 of the screw plate 110) at some, or all, positions of the screw plate 110 as the screw plate 110 moves relative to the clamp housing 102 and accordingly the at least one screw stability mechanism 212a can be configured to apply a rotational impediment force on the screw plate 110 (e.g., at the axle 114) to restrict rotational movement of the screw plate 110 and, thereby, restrict movement of the screw member 108 in the direction 109. And, the at least one screw stability mechanism 212b can be positioned to contact the screw plate 110 at some, but not all, positions of the screw plate 110 as the screw plate 110 moves relative to the clamp housing 102 and accordingly the at least one screw stability mechanism 212b can be configured to apply a rotational impediment force on the screw plate 110, at some, but not all, rotational positions of the screw plate 110, to restrict rotational movement of the screw plate 110 and, thereby, restrict movement of the screw member 108 in the direction 109.

The at least one screw stability mechanism 212 in the form of a change in an angle of a wall 116, 117 at the clamp housing 102, including at the screw plate housing portion 103, can be present in a variety of configurations. For instance, an angle of one or more walls 116 (e.g., at two opposite sidewalls) at the clamp housing 102 and/or one or more walls 117 (e.g., at two opposite sidewalls) at the screw plate housing portion 103 can be changed (e.g., increased or decreased) to provide progressively increasing friction/resistance between the wall(s) 116, 117 and the screw plate 110 to which the screw member 108 is coupled. Namely, in one example, the angle of one or more walls 116 at the clamp housing 102 and/or one or more walls 117 at the screw plate housing portion 103 can taper, or reduce, in a direction along such wall(s) 116, 117 moving toward the band member 104. In another example, an angle of one or more walls 117 of the screw plate housing portion 103 can taper, or reduce, in a direction along the wall 117 moving toward the axle 114.

As one specific such example of the at least one screw stability mechanism 212 in the form of a change in an angle of a wall 116, 117 at the clamp housing 102, the at least one screw stability mechanism 212 can include a change in an angle of the wall 116 of the clamp housing 102 at one or more regions of the wall 116 (e.g., sidewall 116) adjacent (e.g., interfacing with) the screw plate housing portion 103 (e.g., adjacent, such as interfacing with, the axle 114). For instance, at one or more locations of the wall 116 (e.g., sidewall 116) adjacent (e.g., interfacing with) the screw plate housing portion 103 (e.g., adjacent, such as interfacing with, the axle 114), the wall 116 (e.g., sidewall 116) of the clamp housing 102 can be angled toward the screw plate housing portion 103. As one such further example, the wall 116 (e.g., sidewall 116) of the clamp housing 102 can be angled so as to be positioned closer to or further from the screw plate housing portion 103 at a location of the wall 116 adjacent the screw plate housing portion 103 than another location of the wall 116 located further from the screw plate housing portion 103.

In addition to or alternative to one or more changes in an angular extension of the wall 116 of the clamp housing 102 at one or more regions of the wall 116 adjacent the screw plate housing portion 103, as another specific such example of the at least one screw stability mechanism 212 in the form of a change in an angle at a wall of the clamp housing 102, the at least one screw stability mechanism 212 can include a change in an angular extension at the wall 117 of the screw plate housing portion 103. The wall 117 can form a fixed dome component that houses the rotatable axle 114. For instance, the wall 117 (e.g., sidewall 117) of the screw plate housing portion 103 can be angled, at one or more locations of the wall 117 (e.g., sidewall 117) adjacent (e.g., interfacing with) the clamp housing 102, so as to be positioned closer to or further from the clamp housing 102 than another portion of the wall 117 located further from the clamp housing 102. As such, the wall 117 which forms at least a portion of the fixed dome component can include the screw stability mechanism as a non-uniform thickness at the fixed dome component that houses the screw plate axle such that this non-uniform thickness of the wall 117 at the fixed dome component can be configured to contact the screw plate axle 114 housed at the fixed dome component and thereby provide at least some degree of resistance to rotation of the screw plate 110 (e.g., resistance against unintentional screw plate rotation).

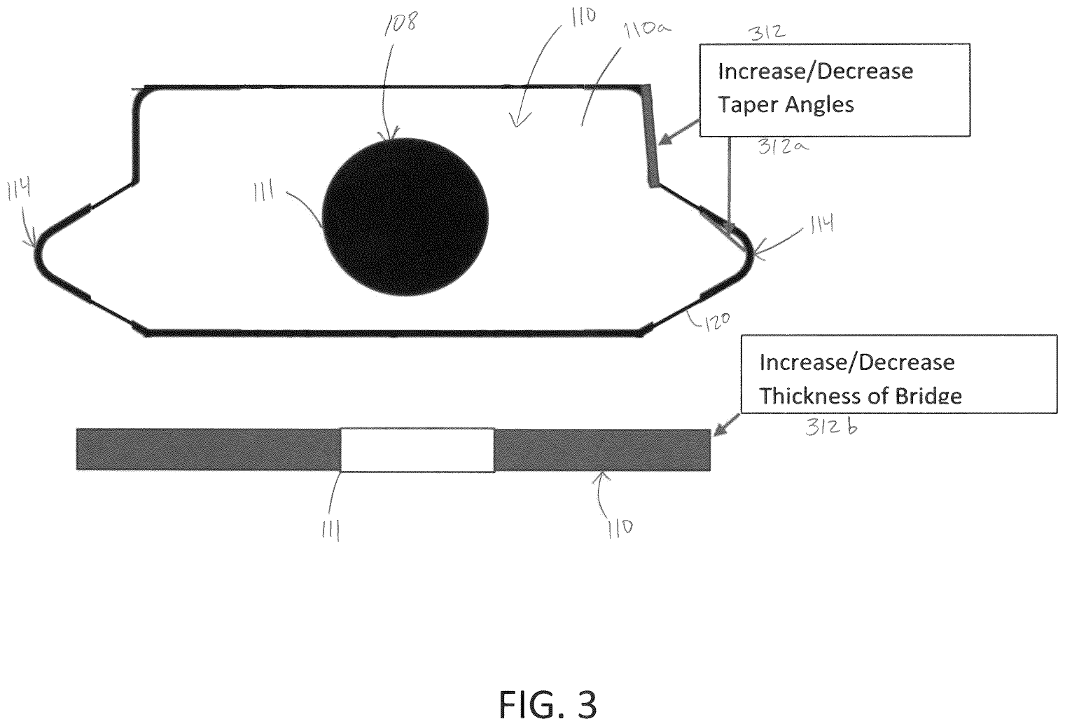

FIG. 3 illustrates two side elevational views, of different sides, of an embodiment of the screw plate 110 for use with a clamp device, such as any clamp device embodiment disclosed elsewhere herein.

As illustrated at FIG. 3, the screw plate 110 includes at least one screw stability mechanism 312 in an exemplary form of a change in thickness of the screw plate 110 as one type of such screw stability mechanism 312b and/or a change in an angle of a wall 120 of the screw plate 110 as another type of such screw stability mechanism 312a. The upper image at FIG. 3 shows the screw stability mechanism 312a as a change (e.g., increase or decrease) in an angle of the wall 120 of the screw plate 110 at a location on the screw plate 110 that is positioned to contact the clamp housing 102 (e.g., at the axle 114 portion of the screw plate 110; at the screw plate housing portion 103 of the clamp housing 102) at some, but not all, positions of the screw plate 110 as the screw plate moves relative to the clamp housing 102. The lower image at FIG. 3 shows the screw stability mechanism 312b as a change in a thickness of the screw plate 110 at a location on the screw plate 110 that is positioned to contact the clamp housing 102 (e.g., a screw plate housing portion 103 of the clamp housing 102) at some, but not all, positions of the screw plate 110 as the screw plate 110 moves relative to the clamp housing 102.

In an additional or alternative embodiment, the screw stability mechanism 312 can include an altered (e.g., increased) profile of the axle 114 portion of the screw plate 110 and/or a change in a geometric shape of the axle 114 portion of the screw plate 110. For instance, the profile of the axle 114 can be altered (e.g., increased) to orient the axle 114 closer to the screw member 108, and thereby reduce the extent of a gap present between the axle 114 and the screw member 108, when the screw member 108 is present at the clamp housing 102 such that the screw member 108 now has a reduced freedom of movement due to the interference force imparted at the screw member 108 when brought in to contact sooner with the increased profile of the axle 114. Similarly, the geometric shape of the axle 114 can be altered to orient the axle 114 closer to the screw member 108, and thereby reduce the extent of a gap present between the axle 114 and the screw member 108, when the screw member 108 is present at the clamp housing 102 such that the screw member 108 now has a reduced freedom of movement due to the interference force imparted at the screw member 108 when brought in to contact sooner with the altered geometric shape of the axle 114.

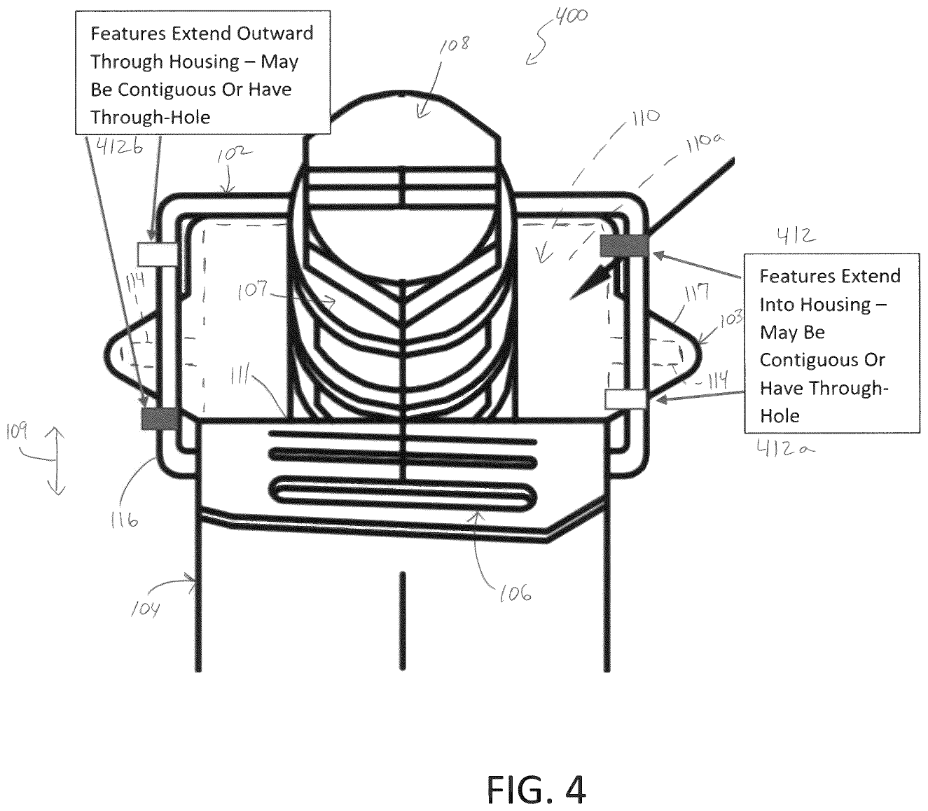

FIG. 4 is a perspective view of an embodiment of a clamp device 400. The clamp device 400 can be similar to, or the same as, the clamp device 100 described with respect to FIG. 1 except as noted here.

The clamp device 400 can include at least one screw stability mechanism 412 in an exemplary form of an interference member 412a, 412b that extends out from the clamp housing 102 (e.g., extends out from the wall 116 of the clamp housing 102). For example, this can include the at least one interference member 412a that extends out from the wall 116 of the clamp housing 102 in a direction toward the screw plate 110 and thus in a direction into the clamp housing 102 and/or the at least one interference member 412b that extends out from the wall 116 of the clamp housing 102 in a direction away the screw plate 110 and thus in a direction outside of the clamp housing 102. The interference member 412a, 412b can be at a location (e.g., at the wall 116) that is positioned to contact the screw plate 110 at some, but not all, positions of the screw plate 110 as the screw plate 110 moves relative to the clamp housing 102. For instance, the interference member 412a can be at a location (e.g., at the wall 116) that is positioned to contact a body 110a of the screw plate 110 at some, but not all, positions of the screw plate 110 as the screw plate body 110a moves relative to the clamp housing 102. And, for instance, the interference member 412b can be at a location (e.g., at the wall 116) that is positioned to contact the axle 114 of the screw plate 110 at some, but not all, positions of the screw plate 110 as the screw plate 110, and axle 114, moves relative to the clamp housing 102.

In certain embodiments, one or more of the interference members 412a, 412b can be include in addition to inclusion of one or more of the other screw stability mechanisms disclosed herein (e.g., screw stability mechanism 112, screw stability mechanism 212, screw stability mechanism 312). The interference members 412a, 412b can include one or more per sidewall 116 and can reside either directly opposite one another on opposite sidewalls 116 in a mirror image or in a staggered, offset orientation. The interference members 412a, 412b be formed as inward facing indentations of the sidewall material, without causing through holes in the sidewall material, or they may be drawn, stamped, coined or otherwise formed in the sidewall material and in so doing partially of fully penetrate the sidewall material (e.g., create hole(s) in the sidewalls). Additionally or alternately, the interference members 412a, 412b can impinge on the opposing sidewalls in an outward direction (from the screw member 108 centerline). Corresponding outward-facing features can be included at the screw plate 110 which could then impinge in an outward direction and “drop” into these sidewall features as the screw member 108 is engaged in a downward direction 109 to the extent that the screw threads 107 contact and lock into the band serrations 106. Such one or more features can help reduce or eliminate screw member 108 looseness in the vertical plane of travel, direction 109, and also lock the threaded screw body 107 securely against the band serrations 106.

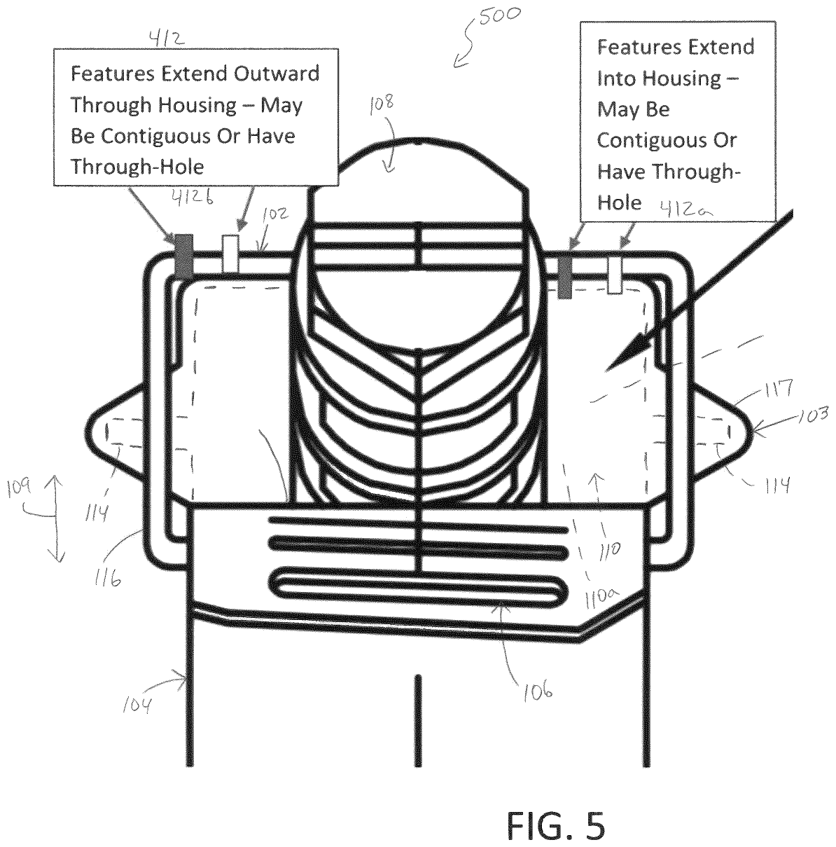

FIG. 5 is a perspective view of an embodiment of a clamp device 500. The clamp device 500 can be similar to, or the same as, the clamp device 100 described with respect to FIG. 1 except as noted here.

As with the clamp device 400 of FIG. 4, the clamp device 500 can include the at least one screw stability mechanism 412 in an exemplary form of an interference member 412a, 412b that extends out from the clamp housing 102. However, the clamp device 500 can include the interference member 412a and/or 412b at a location, different from that illustrated for the embodiment of the clamp device 400 at FIG. 4. Namely, the interference member 412a and/or 412b can be included at the clamp device 500 at a top of the clamp housing 102 (e.g., a surface of the clamp housing 102 opposite the band member 104) and at a position to contact the clamp housing 102 at some, but not all, positions of the screw plate 110 as the screw plate 110 moves relative to the clamp housing 102. As with the clamp device 400, the clamp device 500 can include the at least one interference member 412a that extends out from the top wall 116 of the clamp housing 102 in a direction toward the screw plate 110 and thus in a direction into the clamp housing 102 and/or the at least one interference member 412b that extends out from the top wall 116 of the clamp housing 102 in a direction away the screw plate 110 and thus in a direction outside of the clamp housing 102.

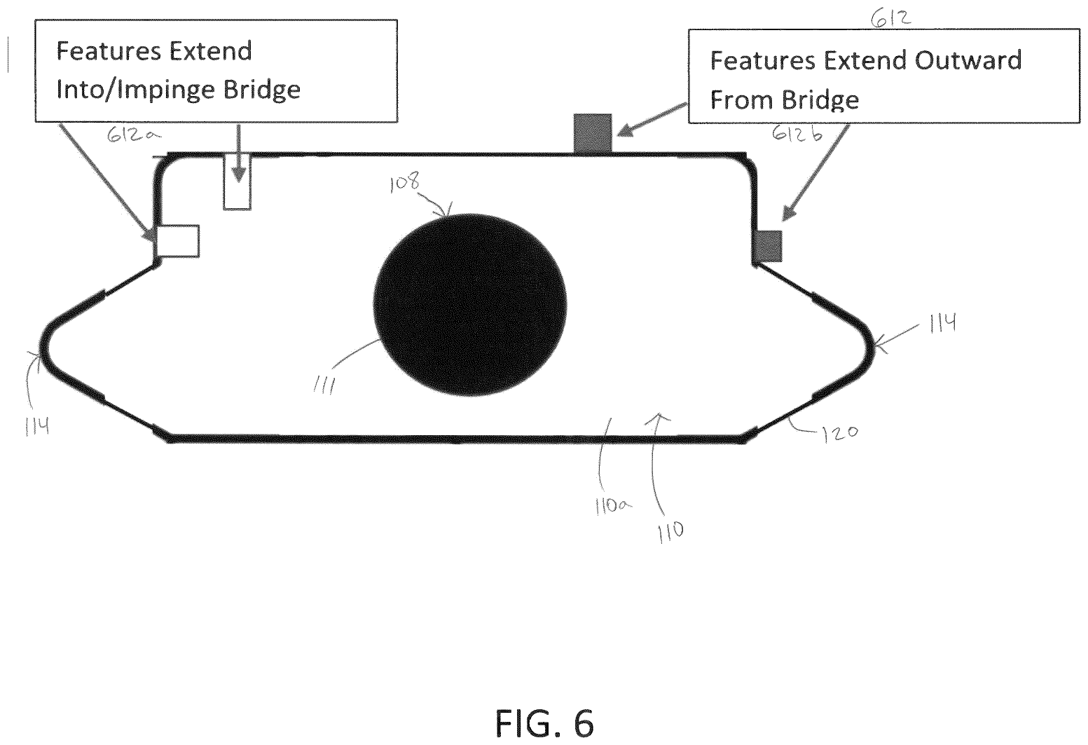

FIG. 6 is a side elevational view of another embodiment of the screw plate 110 for use with a clamp device, such as any clamp device embodiment disclosed elsewhere herein.

The illustrated embodiment of the screw plate 110 at FIG. 6 includes at least one screw stability mechanism 612 in an exemplary form of an interference member 612a that extends inward toward the screw late body 110a at a location that is positioned to contact the clamp housing 102 at some, but not all, positions of the screw plate 110 as the screw plate 110 moves relative to the clamp housing 102 and/or an interference member 612b that extends out from the screw plate body 110a at a location that is positioned to contact the clamp housing 102 at some, but not all, positions of the screw plate 110 as the screw plate 110 moves relative to the clamp housing 102. As illustrated, the interference member 612a can extend inward, toward the screw late body 110a at a location that is positioned to contact the clamp housing 102 at some, but not all, positions of the screw plate 110 as the screw plate 110 moves relative to the clamp housing 102, from the wall 120 of the screw plate 110. And, as also illustrated, the interference member 612b can extend outward, away from the screw plate body 110a at a location that is positioned to contact the clamp housing 102 at some, but not all, positions of the screw plate 110 as the screw plate 110 moves relative to the clamp housing 102, from the wall 120 of the screw plate 110.

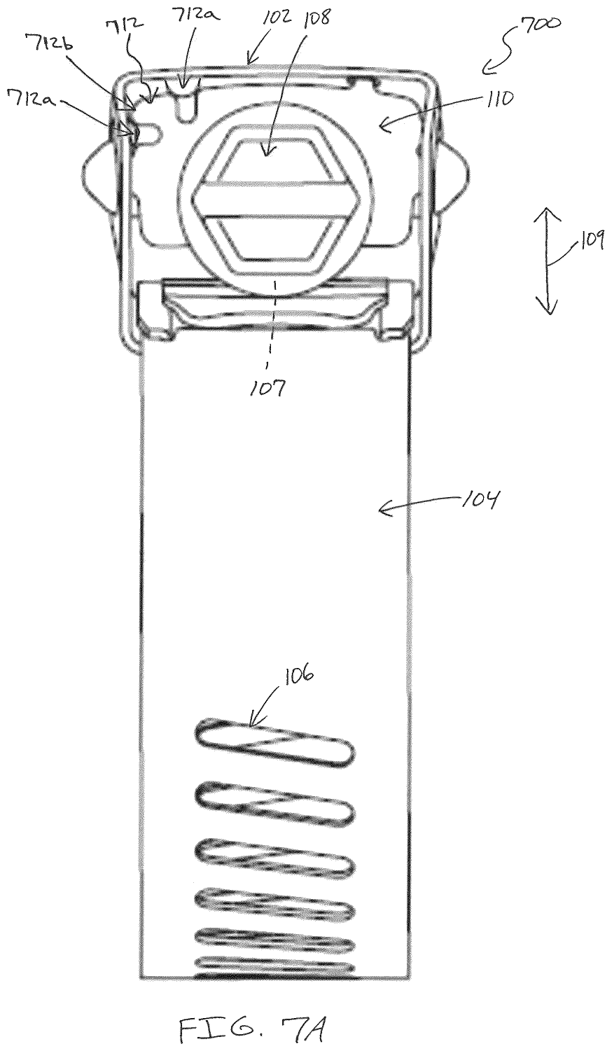

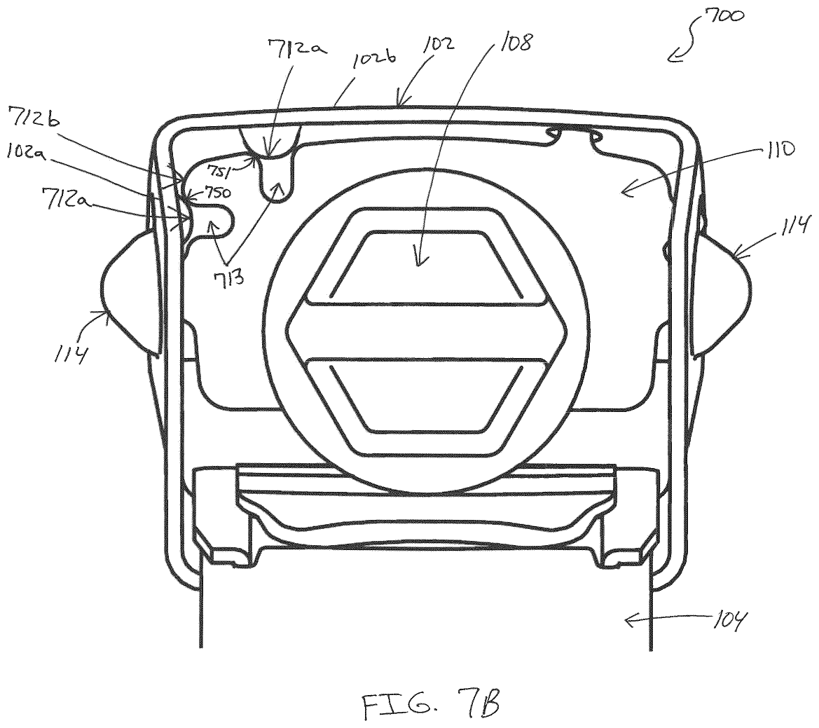

FIGS. 7A and 7B show another embodiment of a clamp device 700 that includes at least one screw stability mechanism in an exemplary form of an interference member that extends out from the screw plate and includes at least one screw stability mechanism in an exemplary form of an interference member that extends out from the clamp housing adjacent to the screw plate's at least one interference member so as to create therebetween an interference contact that is configured to provide tactile feedback to a user when the user applies a force to move the screw member toward the band member to engage to screw member's serrations at the band member's serrations. In particular, FIG. 7A is an elevational view of this clamp device embodiment and FIG. 7B is a close up elevational view of the clamp housing and screw plate showing the screw stability mechanism, in the form of an interference member, at each of the clamp housing and the screw plate. The clamp device 700 illustrated here is a quick release worm gear clamp as one example implementation of the features disclosed herein. The clamp device 700 can be similar to the other clamp devices disclosed herein except as otherwise illustrated and described here with respect to FIGS. 7A and 7B.

As shown at FIGS. 7A and 7B, the clamp device 700 includes the clamp housing 102, the band member 104, the screw member 108, the screw plate 110, and at least one screw stability mechanism 712 at the clamp device 700. In particular, this illustrated embodiment of the clamp device 700 includes the screw stability mechanism 712 as one or more interference members 712a at the clamp housing 102 (e.g., two interference members 712a at different sidewalls of the clamp housing 102) and one or more interference members 712b at the screw plate 110. As with the other exemplary clamp embodiments disclosed herein, the plurality of first mating features 106 are included and defined at the band member 104, and the plurality of second mating features 107 are included and defined at the screw member 108. As noted previously herein, to help facilitate installation of the clamp device 700 at various angles, the screw member 108 can be configured to move relative to the clamp housing 102. For example, the screw member 108 can be configured to move in the direction 109 generally normal to the band member 104, for instance generally normal to a portion of the band member 104 received at the clamp housing 102. The screw member 108 can be coupled to the screw plate 110 and the screw plate 110 can be rotatably coupled to the clamp housing 102 via axles 114 at the screw plate 110 such that as the screw plate 110 rotates relative to the clamp housing 102 via axles 114, the screw member 108 is caused to move in the direction 109.

To help increase the reliability and installation efficiency associated with the clamp device 700, the clamp device 700 can include the at least one screw stability mechanism 712 at the clamp device 700. As described previously herein, the at least one screw stability mechanism 712 can be configured to reduce at least one degree of freedom of movement of the screw member 108 relative to the band member 104, for instance, be configured to reduce at least one degree of freedom of movement of the screw member 108, relative to the band member 104, in the direction 109.

This illustrated embodiment of the clamp device 700 at FIGS. 7A and 7B includes the screw stability mechanism 712 as at least two interference members 712a at different sidewalls of the clamp housing 102 and at least one interference members 712b at the screw plate 110. As illustrated here, the at least two interference members 712a are each in the form of a dimple that protrudes outward from the respective, different clamp housing 102 sidewalls into the interior of the clamp housing 102 adjacent to the screw plate 110. Also as illustrated here, the at least one interference member 712b is in the form of a flange 712b at the screw plate 110, where this flange 712b is positioned between, and contacts, the two interference members 712a at different sidewalls of the clamp housing 102. Thus, the illustrated embodiment at FIGS. 7A and 7B shows the arrangement of the protruded dimples, forming the interference members 712a, in contact with different portions of the flange, forming the interference member 712b. Namely, the flange can include a first flange perimeter surface 750 that contacts one of the dimples 712a that extends from a first sidewall 102a of the clamp housing 102 and a second, different flange perimeter surface 751 that contacts the other of the dimples 712a that extends from a second, different sidewall 102b of the clamp housing 102. For the illustrated embodiment, the first flange perimeter surface 750 is at on opposite side of the flange 712b from the second flange perimeter surface 751. The interference members 712, 712b can act to provide a degree of resistance against movement of the screw member 108 in the direction 109 of movement of the screw member 108 and, thereby, help to reduce instances of “flop” associated with the screw member 108 during installation. For example, the contact between the protruded dimples 712a and the flange 712b that extends between the protruded dimples 712a can act to provide a degree of resistance to rotational movement of the screw plate 110 at the clamp housing 102 which can act to provide tactile feedback to a user who is apply force at the screw member 108, in the direction 109, to cause the screw plate 110 to rotate relative to the clamp housing 102. As illustrated, the flange 712b at the screw plate 110 can be located between the first and second axles 114 (e.g., and with the flange 712b located between the first and second axles 114 at a different elevation on the screw plate 110 than an elevation of the first and second axles 114 on the screw plate 110).

The illustrated embodiment of the screw plate 110 includes, in addition to the flange 712b, cutouts 713. As shown, the screw plate 110 can include one cutout 713 adjacent one dimple 712a such that the cutout 713 extends inward generally from the sidewall 102a and another cutout 713 adjacent the other dimple 712a such that the cutout 713 extends inward generally from the sidewall 102b. The screw plate 110 can receive the dimple 712, which extends out from the sidewall 102a, at the cutout 713 adjacent that sidewall 102a and the screw plate 110 can receive the dimple 712, which extends out from the sidewall 102b, at the cutout 713 adjacent that sidewall 102b. As also shown, the flange 712b can extend out from the screw plate 110 at a location between the cutouts 113 such that the flange 712b is generally bounded on each side by the cutouts 113. The presence of the cutouts 713 at the screw plate 110 at locations generally aligned with the dimples 712a can facilitate the presence of such dimples 712a extending inward from the clamp housing 102.

The screw stability mechanism 712, via the contact between the protruding dimples 712a and the flange 712b, can be configured to restrict rotational movement of the screw plate 110 relative to the clamp housing 102 and band 104, and this restricted rotational movement of the screw plate 110 can act to restrict movement of the screw member 108 in the direction 109. As a result, the degree of force a user needs to exert at the clamp device 700 can be greater than that needed for typical clamps without a screw stability mechanism (e.g., and can provide tactile feedback to the user as the user applies force at the clamp device 700 to move the screw member 108 in the direction 109). Accordingly, the screw member 108 of the clamp device 700 can be configured to have restricted movement in the direction 109 relative to a same or similar clamp device lacking a screw stability mechanism and thereby help to reduce instances of screw member 108 flop, in the direction 109, when installing the clamp device 700.

As noted elsewhere herein, embodiments are contemplated within the scope of the present disclosure that include any combination of screw stability mechanisms from any one or more of the illustrated clamp device and screw plate embodiments. As one illustrative such example, one embodiment could include one or more of the screw stability mechanism(s) 112 disclosed with respect to FIG. 1, the screw stability mechanism(s) 212 disclosed with respect to FIG. 2, the screw stability mechanism(s) 312 disclosed with respect to FIG. 3, the screw stability mechanism(s) 412 disclosed with respect to FIGS. 4 and 5, and/or the screw stability mechanism(s) 612 disclosed with respect to FIG. 6. In some applications, incorporation of more than one type of screw stability mechanism disclosed herein with respect to any one or more of the various exemplary embodiments can help to provide additional stability at the screw member 108 and, thereby, help to further reduce unintended instances of screw member “flop” and help to increase installation efficiency associated with the particular embodiment of the clamp device.

Various examples of the disclosure have been described. Any combination of the described systems, operations, or functions is contemplated.

What is claimed is:

1. A quick release worm gear clamp comprising:
a clamp housing;
a band member movable relative to the clamp housing, the band member including a plurality of first mating features;
a screw member movable relative to the clamp housing and the band member, the screw member including a plurality of second mating features, the plurality of second mating features complementary to the plurality of first mating features such that the plurality of second mating features are configured to engage with the plurality of first mating features when the screw member is moved in a first direction to bring the screw member into contact with the band member;
a screw plate movably coupled to the clamp housing, the screw member coupled to the screw plate such that as the screw member is moved in the first direction the screw plate is moved relative to the clamp housing; and
a screw stability mechanism at the clamp housing and/or at the screw plate, the screw stability mechanism configured to provide an interference force that increases a resistance to movement of the screw member in the first direction.

2. The clamp of claim 1, wherein the screw stability mechanism comprises a first interference member at the clamp housing and a second interference member at the screw plate.

3. The clamp of claim 2, wherein the first interference member is configured to contact the second interference member to provide the interference force that increases the resistance to movement of the screw member in the first direction toward the band member.

4. The clamp of claim 3, wherein the first interference member at the clamp housing comprises a first dimple that protrudes out from a first sidewall of the clamp housing into an interior of the clamp housing.

5. The clamp of claim 4, wherein the first interference member at the clamp housing further comprises a second dimple that protrudes out from a second sidewall of the clamp housing into the interior of the clamp housing, the second sidewall being different than the first sidewall.

6. The clamp of claim 5, wherein the first sidewall is adjacent to the second sidewall.

7. The clamp of claim 6, wherein the second interference member at the screw plate comprises a flange positioned between the first dimple and the second dimple.

8. The clamp of claim 7, wherein the flange contacts the first dimple and the second dimple to provide the interference force that increases the resistance to movement of the screw member in the first direction toward the band member.

9. The clamp of claim 8, wherein the flange includes a first flange perimeter surface and a second flange perimeter surface that is different than the first flange perimeter surface, wherein the first flange perimeter surface is configured to contact the first dimple within the clamp housing, and wherein the second flange perimeter surface is configured to contact the second dimple within the clamp housing.

10. The clamp of claim 9, wherein the first flange perimeter surface is opposite the second flange perimeter surface.

11. The clamp of claim 10, wherein the screw plate defines a first cutout adjacent the first dimple and extending inward at the screw plate adjacent the first sidewall, and wherein the screw plate defines a second cutout adjacent the second dimple and extending inward at the screw plate adjacent the second sidewall.

12. The clamp of claim 11, wherein the screw plate receives the first dimple at the first cutout adjacent the first sidewall, and wherein the screw plate receives the second dimple at the second cutout adjacent the second sidewall.

13. The clamp of claim 12, wherein the flange extends out from the screw plate within the clamp housing at a location between the first cutout and the second cutout.

14. The clamp of claim 11, wherein the screw plate further comprises a first axle rotationally coupled to the clamp housing and a second axle rotationally coupled to the clamp housing, and wherein the flange is located between the first axle and the second axle.

15. The clamp of claim 14, wherein the flange is located between the first axle and the second axle at a different elevation on the screw plate than an elevation of the first axle and the second axle on the screw plate.

16. The clamp of claim 11, wherein, when the plurality of second mating features are engaged with the plurality of first mating features, the clamp is configured such that actuation of the screw member causes the band member to move relative to the clamp housing so as to tighten or loosen the band member.

17. The clamp of claim 16, wherein the clamp is configured such that actuation of the screw member in a first direction causes the band member to move relative to the clamp housing in a first direction so as to tighten the band member, and wherein the clamp is configured such that actuation of the screw member in a second, opposite direction causes the band member to move relative to the clamp housing in a second, opposite direction so as to loosen the band member.

18. The clamp of claim 1, wherein the screw stability mechanism comprises a sidewall of the clamp housing, and wherein the sidewall of the clamp housing comprises a skewed sidewall orientation relative to the screw plate.

19. The clamp of claim 1, wherein the screw stability mechanism comprises a non-uniform thickness at a sidewall of the clamp housing, and wherein the non-uniform thickness at the sidewall of the clamp housing comprises an increase in sidewall thickness at a location at the clamp housing configured to contact the screw plate.

20. The clamp of claim 1, wherein the screw stability mechanism comprises a non-uniform thickness at an axle of the screw plate, and wherein the non-uniform thickness at the axle of the screw plate is configured to contact the clamp housing.
